(19) United States
(12) Patent Application Publication
(10) Pub. No.: US 2022/0261703 A1
(43) Pub. Date: Aug. 18, 2022

(54) INFORMATION PROCESSING DEVICE, STORAGE MEDIUM, AND INFORMATION PROCESSING METHOD

(71) Applicant: TOYOTA JIDOSHA KABUSHIKI KAISHA, Toyota-shi (JP)

(72) Inventors: Yuka TAKIGUCHI, Toyota-shi (JP); Tetsushi OKAMOTO, Miyoshi-shi (JP); Hirokazu KOBAYASHI, Toyota-shi (JP); Minoru NAKADORI, Toyota-shi (JP); Daiki KANEICHI, Tokyo (JP)

(73) Assignee: TOYOTA JIDOSHA KABUSHIKI KAISHA, Toyota-shi (JP)

(21) Appl. No.: 17/592,642

(22) Filed: Feb. 4, 2022

(30) Foreign Application Priority Data
Feb. 17, 2021 (JP) 2021-023763

(51) Int. Cl. G06Q 10/02

(52) U.S. Cl. CPC G06Q 10/02; G06Q 30/0645

(57) ABSTRACT

A processor is configured to: acquire either reservation use information or on-demand use information as request information for use of vehicles from a user, the reservation use information being information on reservation use in which the user makes an advance reservation of the vehicles, and the on-demand use information being information on on-demand use in which use of the vehicles parked in an on-demand waiting area by the user is accepted; manage a usage schedule of the vehicles by the same number of reservation tables as the number of the vehicles; and when the processor acquires the reservation use information, determine, at a time point, which vehicle is designated as a vehicle to be used for the reservation use in a reservation table corresponding to the reservation use, the time point being a predetermined time before start time of the reservation use.

### CROSS-REFERENCE TO RELATED APPLICATION

This application claims priority to Japanese Patent Application No. 2021-023763 filed on Feb. 17, 2021, incorporated herein by reference in its entirety.

### BACKGROUND

### 1. Technical Field

The present disclosure relates to information processing devices, storage media, and information processing methods.

### 2. Description of Related Art

As car sharing services become more widespread, various technologies for managing vehicles that are used for the car sharing services are being studied.

For example, Japanese Unexamined Patent Application Publication No. 2017-102553 (JP 2017-102553 A) discloses a vehicle management system capable of rationally sharing vehicles between a car sharing service and a car rental service by combining vehicle management for the car sharing service and vehicle management for the car rental service.

### SUMMARY

It would be convenient for users who use a car sharing service if they could use the car sharing service in two ways: reservation use in which the user makes an advance reservation to use a shared car, and on-demand use in which the user requests and uses a shared car on the spot.

It is an object of the present disclosure to make it possible to facilitate both reservation use and on-demand use in car sharing services.

An aspect of the present disclosure relates to an information processing device that manages vehicles used for a car sharing service, the information processing device comprising a processor configured to: acquire either reservation use information or on-demand use information as request information for use of the vehicles from a user, the reservation use information being information on reservation use in which the user makes an advance reservation of the vehicles, and the on-demand use information being information on on-demand use in which use of the vehicles parked in an on-demand waiting area by the user is accepted; manage a usage schedule of the vehicles by the same number of reservation tables as the number of the vehicles; and when the processor acquires the reservation use information, determine, at a time point, which vehicle is designated as a vehicle to be used for the reservation use in a reservation table corresponding to the reservation use, the time point being a predetermined time before start time of the reservation use.

Another aspect of the present disclosure relates to a non-transitory computer-readable storage medium storing a program, the program being a program that, when executed by a processor, causes a computer that manages vehicles used for a car sharing service to: acquire either reservation use information or on-demand use information as request information for use of the vehicles from a user, the reservation use information being information on reservation use in which the user makes an advance reservation of the vehicles, and the on-demand use information being information on on-demand use in which use of the vehicles parked in an on-demand waiting area by the user is accepted; manage a usage schedule of the vehicles by the same number of reservation tables as the number of the vehicles; and when the computer acquires the reservation use information, determine, at a time point, which vehicle is designated as a vehicle to be used for the reservation use in a reservation table corresponding to the reservation use, the time point being a predetermined time before start time of the reservation use.

Another aspect of the present disclosure relates to an information processing method in an information processing device that manages vehicles used for a car sharing service, the information processing method comprising: acquiring either reservation use information or on-demand use information as request information for use of the vehicles from a user, the reservation use information being information on reservation use in which the user makes an advance reservation of the vehicles, and the on-demand use information being information on on-demand use in which use of the vehicles parked in an on-demand waiting area by the user is accepted; managing a usage schedule of the vehicles by the same number of reservation tables as the number of the vehicles; and when the reservation use information is acquired, determining, at a time point, which vehicle is designated as a vehicle to be used for the reservation use in a reservation table corresponding to the reservation use, the time point being a predetermined time before start time of the reservation use.

According to the present disclosure, it is possible to facilitate both reservation use and on-demand use in car sharing services.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows a configuration of an information processing system according to an embodiment of the present disclosure;

FIG. 2 is a block diagram showing a configuration of an information processing device according to the embodiment of the present disclosure;

FIG. 3 is a block diagram showing a configuration of a terminal device according to the embodiment of the present disclosure;

FIG. 4 is a block diagram illustrating a configuration of a vehicle according to the embodiment of the present disclosure;

FIG. 5 is a block diagram showing a configuration of a server device according to the embodiment of the present disclosure;

FIG. 6 shows an example of a parking area;

FIG. 7 is a flowchart showing an example of the operation of the information processing system according to the embodiment of the present disclosure for reservation use;

FIG. 8 is a flowchart showing an example of the operation of the information processing system according to the embodiment of the present disclosure for on-demand use;

FIG. 9 shows an example in which available times for reservation use are displayed;

FIG. 10 shows an example of display when a user is performing an input operation for reservation use;

FIG. 11 shows an example in which an available time for on-demand use is displayed;

FIG. 12 shows an example of display when the user is performing an input operation for on-demand use;

FIG. 13 shows an example of reservation tables;

FIG. 14 shows an example in which a new reservation has been added to the reservation table;

FIG. 15 shows an example of reservation tables for a plurality of vehicle models;

FIG. 16 shows an example of reservation tables when four users have made a reservation;

FIG. 17 shows an example in which there are two parking areas;

FIG. 18 shows an example of reservation tables when a request for on-demand use has been accepted; and

FIG. 19 shows an example of reservation tables when the reservation table is linked to a vehicle parked in an on-demand waiting area.

### DETAILED DESCRIPTION OF EMBODIMENTS

Hereinafter, an embodiment of the present disclosure will be described with reference to the drawings.

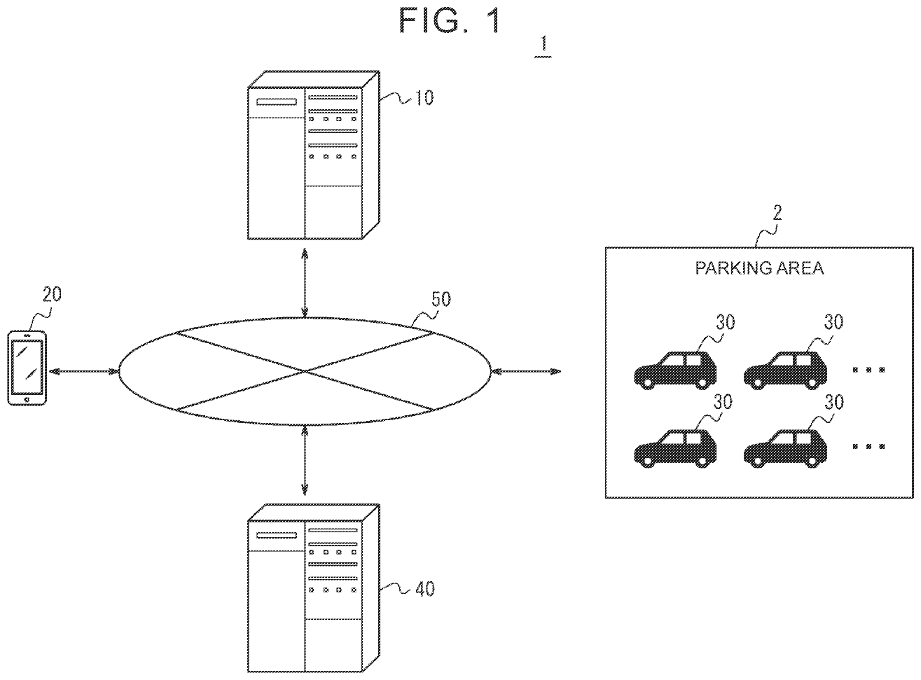

FIG. 1 shows a configuration of an information processing system 1 according to an embodiment of the present disclosure. The configuration and overview of the information processing system 1 according to the embodiment of the present disclosure will be described with reference to FIG. 1.

The information processing system 1 includes an information processing device 10, a terminal device 20, vehicles 30, and a server device 40. The information processing device 10, the terminal device 20, the vehicles 30, and the server device 40 are connected to each other via a network 50 so that they can communicate with each other. The network 50 may be a network including a mobile communication network, the Internet, etc.

Although FIG. 1 shows one information processing device 10, one terminal device 20, and one server device 40, the information processing system 1 may include two or more information processing devices 10, two or more terminal devices 20, and two or more server devices 40.

The vehicles 30 are vehicles that are used for a car sharing service. The vehicles 30 wait in a parking area 2 when they are not being used by a user. The information processing device 10 may manage any number of vehicles 30 for the car sharing service.

For example, the information processing device 10 is a dedicated computer configured to function as a server. The information processing device 10 may be a general-purpose personal computer (PC).

The information processing device 10 can communicate with the terminal device 20, the vehicles 30, and the server device 40 via the network 50. The information processing device 10 manages the vehicles 30 that are used for the car sharing service.

The terminal device 20 is a terminal device carried by the user who uses the car sharing service. For example, the terminal device 20 may be a smartphone or a tablet.

The terminal device 20 can communicate with the information processing device 10, the vehicles 30, and the server device 40 via the network 50.

For example, the vehicles 30 are any type of automobiles such as gasoline vehicles, diesel vehicles, hybrid electric vehicles (HEVs), plug-in hybrid electric vehicles (PHEVs), battery electric vehicles (BEVs), or fuel cell electric vehicles (FCEVs). The vehicles 30 are vehicles capable of autonomous driving. The vehicles 30 are vehicles having an automated valet parking (AVP) function. That is, when the user uses the car sharing service, the vehicle 30 can autonomously move to a place where the user picks up the vehicle 30. When the user finishes using the car sharing service and drops off the vehicle 30, the vehicle 30 can autonomously move to a waiting space for the vehicles 30 that are not being used.

The vehicles 30 can communicate with the information processing device 10, the terminal device 20, and the server device 40 via the network 50.

The server device 40 is a dedicated computer configured to function as a server. The server device 40 may be a general-purpose PC.

The server device 40 can communicate with the information processing device 10, the terminal device 20, and the vehicles 30 via the network 50. The server device 40 monitors the status of each vehicle 30 in the parking area 2. The server device 40 sends the status of each vehicle 30 in the parking area 2 to the information processing device 10. For example, the server device 40 may monitor the status of each vehicle 30 in the parking area 2 based on data acquired from a camera, sensor, etc. installed in the parking area 2.

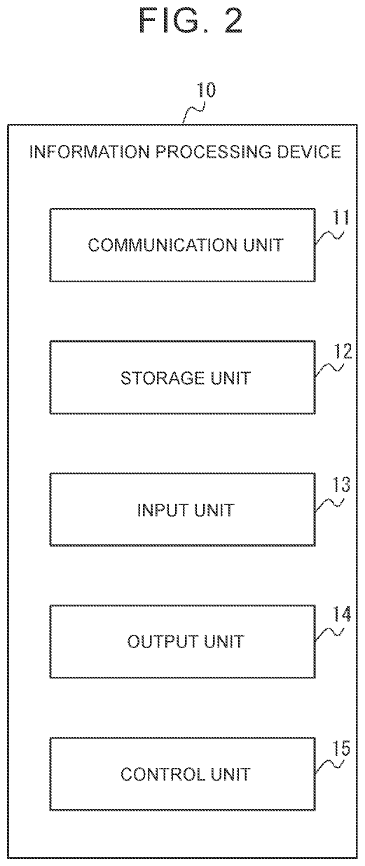

The configuration of the information processing device 10 according to the embodiment of the present disclosure will be described with reference to FIG. 2.

The information processing device 10 includes a communication unit 11, a storage unit 12, an input unit 13, an output unit 14, and a control unit 15.

The communication unit 11 includes a communication module connected to the network 50. For example, the communication unit 11 may include a communication module compatible with a local area network (LAN). In one embodiment, the information processing device 10 is connected to the network 50 via the communication unit 11. The communication unit 11 sends and receives various kinds of information via the network 50. The communication unit 11 can communicate with the terminal device 20, the vehicles 30, and the server device 40 via the network 50.

For example, the storage unit 12 is, but not limited to, a semiconductor memory, a magnetic memory, or an optical memory. For example, the storage unit 12 may function as a main storage device, an auxiliary storage device, or a cache memory. The storage unit 12 stores any information to be used for the operation of the information processing device 10. For example, the storage unit 12 may store a system program, an application program, and various kinds of information received by the communication unit 11. For example, the information stored in the storage unit 12 may be updatable with information received from the network 50 via the communication unit 11. A part of the storage unit 12 may be installed outside the information processing device 10. In this case, the part of the storage unit 12 installed outside the information processing device 10 may be connected to the information processing device 10 via a desired interface.

The input unit 13 includes one or more input interfaces that detect user input and acquire input information based on the user's operation. For example, the input unit 13 includes, but not limited to, a physical key, a capacitive key, a touch screen integrated with a display of the output unit 14, or a microphone that accepts voice input.

The output unit 14 includes one or more output interfaces that output information to notify the user. For example, the output unit 14 includes, but not limited to, a display that outputs information as images or a speaker that outputs information as audio.

The control unit 15 includes at least one processor, at least one dedicated circuit, or a combination thereof. The processor is a general-purpose processor such as central processing unit (CPU) or graphics processing unit (GPU), or a dedicated processor specialized for a specific process. For example, the dedicated circuit is a field-programmable gate array (FPGA) or an application-specific integrated circuit (ASIC). The control unit 15 can perform processes related to the operation of the information processing device 10 while controlling various units of the information processing device 10.

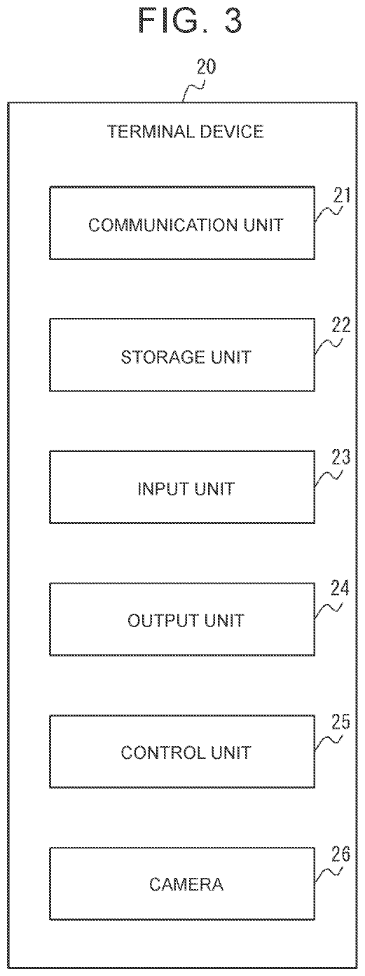

The configuration of the terminal device 20 according to the embodiment of the present disclosure will be described with reference to FIG. 3.

The terminal device 20 includes a communication unit 21, a storage unit 22, an input unit 23, an output unit 24, a control unit 25, and a camera 26.

The communication unit 21 includes a communication module connected to the network 50. For example, the communication unit 21 may include a communication module compatible with mobile communication standards such as Long-Term Evolution (LTE), 4th generation (4G), and 5th generation (5G). In one embodiment, the terminal device 20 is connected to the network 50 via the communication unit 21. The communication unit 21 sends and receives various kinds of information via the network 50. The communication unit 21 can communicate with the information processing device 10, the vehicles 30, and the server device 40 via the network 50.

For example, the storage unit 22 is, but not limited to, a semiconductor memory, a magnetic memory, or an optical memory. For example, the storage unit 22 may function as a main storage device, an auxiliary storage device, or a cache memory. The storage unit 22 stores any information to be used for the operation of the terminal device 20. For example, the storage unit 22 may store a system program, an application program, and various kinds of information received by the communication unit 21. For example, the information stored in the storage unit 22 may be updatable with information received from the network 50 via the communication unit 21. A part of the storage unit 22 may be installed outside the terminal device 20. In this case, the part of the storage unit 22 installed outside the terminal device 20 may be connected to the terminal device 20 via a desired interface.

The input unit 23 includes one or more input interfaces that detect user input and acquire input information based on the user's operation. For example, the input unit 23 includes, but not limited to, a physical key, a capacitive key, a touch screen integrated with a display of the output unit 24, or a microphone that accepts voice input.

The output unit 24 includes one or more output interfaces that output information to notify the user. For example, the output unit 24 includes, but not limited to, a display that outputs information as images or a speaker that outputs information as audio.

The control unit 25 includes at least one processor, at least one dedicated circuit, or a combination thereof. The processor is a general-purpose processor such as CPU or GPU, or a dedicated processor specialized for a specific process. For example, the dedicated circuit is an FPGA or an ASIC. The control unit 25 performs processes related to the operation of the terminal device 20 while controlling each unit of the terminal device 20.

The camera 26 is a camera capable of capturing images.

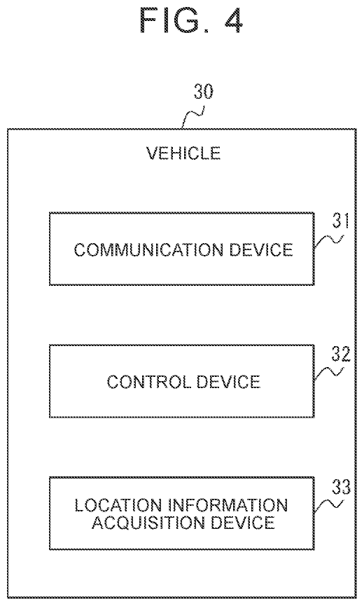

The configuration of the vehicle 30 according to the embodiment of the present disclosure will be described with reference to FIG. 4.

The vehicle 30 includes a communication device 31, a control device 32, and a location information acquisition device 33. The communication device 31, the control device 32, and the location information acquisition device 33 are connected to each other via an in-vehicle network such as Controller Area Network (CAN) or a dedicated line so that they can communicate with each other.

The communication device 31 includes a communication module connected to the network 50. For example, the communication device 31 may include a communication module compatible with mobile communication standards such as LTE, 4G, and 5G. In one embodiment, the vehicle 30 is connected to the network 50 via the communication device 31. The communication device 31 sends and receives various kinds of information via the network 50. The communication device 31 can communicate with the information processing device 10, the terminal device 20, and the server device 40 via the network 50.

The control device 32 includes at least one processor, at least one dedicated circuit, or a combination thereof. The processor is a general-purpose processor such as CPU or GPU, or a dedicated processor specialized for a specific process. For example, the dedicated circuit is an FPGA or an ASIC. The control device 32 performs processes related to the operation of the vehicle 30 while controlling each unit of the vehicle 30.

The location information acquisition device 33 includes one or more receivers compatible with a desired satellite positioning system. For example, the location information acquisition device 33 may include a Global Positioning System (GPS) receiver. The location information acquisition device 33 acquires a measured value of the location of the vehicle 30 as location information. For example, the location information includes an address, latitude, longitude, and altitude.

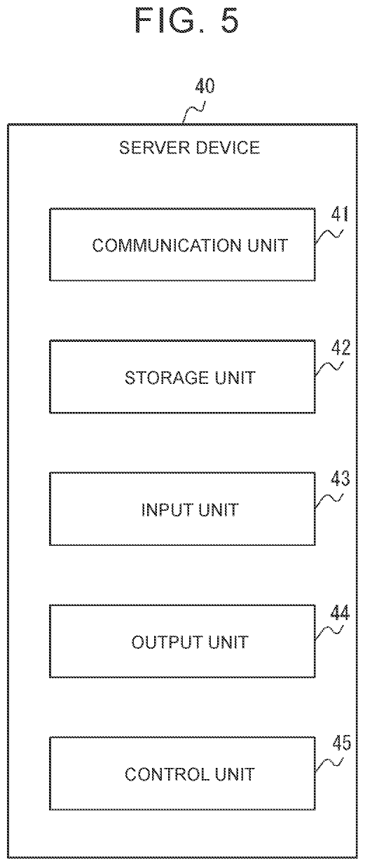

The configuration of the server device 40 according to the embodiment of the present disclosure will be described with reference to FIG. 5.

The server device 40 includes a communication unit 41, a storage unit 42, an input unit 43, an output unit 44, and a control unit 45.

The communication unit 41 includes a communication module connected to the network 50. For example, the communication unit 41 may include a communication module compatible with a LAN. In one embodiment, the server device 40 is connected to the network 50 via the communication unit 41. The communication unit 41 sends and receives various kinds of information via the network 50. The communication unit 41 can communicate with the information processing device 10, the terminal device 20, and the vehicles 30 via the network 50.

For example, the storage unit 42 is, but not limited to, a semiconductor memory, a magnetic memory, or an optical memory. For example, the storage unit 42 may function as a main storage device, an auxiliary storage device, or a cache memory. The storage unit 42 stores any information to be used for the operation of the server device 40. For example, the storage unit 42 may store a system program, an application program, and various kinds of information received by the communication unit 41. For example, the information stored in the storage unit 42 may be updatable with information received from the network 50 via the communication unit 41. A part of the storage unit 42 may be installed outside the server device 40. In this case, the part of the storage unit 42 installed outside the server device 40 may be connected to the server device 40 via a desired interface.

The input unit 43 includes one or more input interfaces that detect user input and acquire input information based on the user's operation. For example, the input unit 43 includes, but not limited to, a physical key, a capacitive key, a touch screen integrated with a display of the output unit 44, or a microphone that accepts voice input.

The output unit 44 includes one or more output interfaces that output information to notify the user. For example, the output unit 44 includes, but is not limited to, a display that outputs information as images or a speaker that outputs information as audio.

The control unit 45 includes at least one processor, at least one dedicated circuit, or a combination thereof. The processor is a general-purpose processor such as CPU or GPU, or a dedicated processor specialized for a specific process. For example, the dedicated circuit is an FPGA or an ASIC. The control unit 45 performs processes related to the operation of the server device 40 while controlling each unit of the server device 40.

Operation of Information Processing System

The operation of the information processing system 1 shown in FIG. 1 will be described.

First, an overview of the car sharing service that is provided by the information processing system 1 will be described.

The vehicles 30 are vehicles that are used for the car sharing service. The vehicles 30 wait in the parking area 2 when they are not being used by the user. Although FIG. 1 shows one parking area 2, there may be a plurality of parking areas 2. When there is a plurality of parking areas 2, the vehicles 30 not being used by the user may wait in each parking area 2.

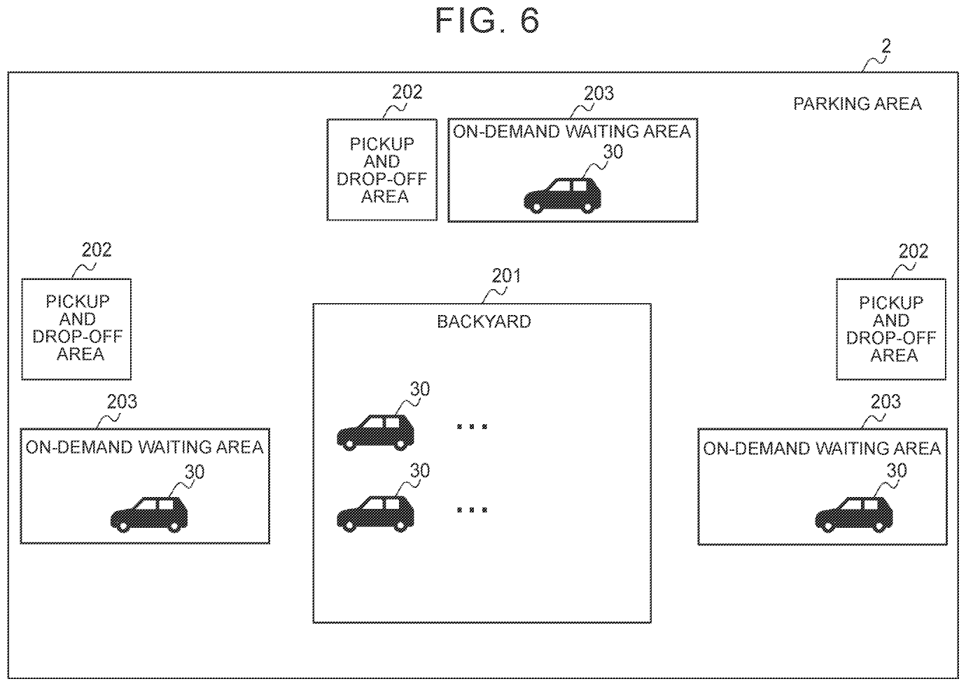

FIG. 6 shows an example of the parking area 2. The parking area 2 is a space where the vehicles 30 not being used by the user can wait. For example, the parking area 2 may be a space provided in the basement of an apartment building in which the user of the car sharing service etc. lives.

The parking area 2 includes a backyard 201, pickup and drop-off areas 202, and on-demand waiting areas 203.

The arrangement of the backyard 201, the pickup and drop-off areas 202, and the on-demand waiting areas 203 shown in FIG. 6 is by way of example. The backyard 201, the pickup and drop-off areas 202, and the on-demand waiting areas 203 may be provided in the parking area 2 in an arrangement other than the arrangement shown in FIG. 6.

In the example shown in FIG. 6, the parking area 2 has one backyard 201. However, the parking area 2 may have two or more backyards 201. In the example shown in FIG. 6, the parking area 2 has three pickup and drop-off areas 202. However, the number of pickup and drop-off areas 202 may be two or less or may be four or more. In the example shown in FIG. 6, the parking area 2 has three on-demand waiting areas 203. However, the number of on-demand waiting areas 203 may be two or less or may be four or more.

The backyard 201 is a space where the vehicles 30 not being used by the user wait. A charger capable of charging the battery of the vehicle 30 is installed in the backyard 201. The battery of the vehicle 30 can be charged in the backyard 201 after the user finished using the vehicle 30.

The vehicle 30 can be cleaned in the backyard 201. A machine capable of automatically cleaning the vehicle 30 may be installed in the backyard 201. A space where a worker can clean the vehicle 30 may be provided in the backyard 201.

The pickup and drop-off area 202 is a space the user can use to pick up and drop off the vehicle 30. When the user starts using the car sharing service, the user can pick up the vehicle 30 in the pickup and drop-off area 202. When the user finishes using the car sharing service, the user can drop off the vehicle 30 in the pickup and drop-off area 202.

The on-demand waiting area 203 is a space where the vehicles 30 available for on-demand use wait. On-demand use will be described later. When using the car sharing service for on-demand use, the user picks up the vehicle 30 parked in the on-demand waiting area 203.

The information processing device 10 manages the vehicles 30 that are used for the car sharing service. The information processing device 10 may manage the vehicles 30 of a plurality of models. For example, when there are 10 vehicles 30 of model A, 10 vehicles 30 of model B, and 10 vehicles 30 of model C, the information processing device 10 manages the 10 vehicles 30 of model A, the 10 vehicles 30 of model B, and the 10 vehicle 30 of model C. By managing the vehicles 30 of the plurality of models, the information processing device 10 can provide the user with the vehicle 30 that matches the purpose.

The information processing device 10 acquires request information for the use of the vehicle 30 from the user. When using the car sharing service, the user uses the terminal device 20 to send request information for the use of the vehicle 30 to the information processing device 10.

In the car sharing service provided by the information processing system 1, the vehicles 30 can be used for both reservation use and on-demand use. The information processing device 10 acquires the request information for the use of the vehicle 30 from the user as either request information for reservation use or request information for on-demand use.

Reservation use is the type of use in which the user makes an advance reservation to use the vehicle 30. For reservation use, the user operates the terminal device 20 to send request information for reservation use to the information processing device 10.

The request information for reservation use that is sent by the user to the information processing device 10 includes information on a desired vehicle model, pickup date and time, scheduled return date and time, and desired pickup location. That is, for reservation use, the user can designate the model of the vehicle 30 he or she wants to use. For reservation use, the user can also designate the period of use of the vehicle 30 by the pickup date and time and the scheduled return date and time. For reservation use, the user can also designate the pickup location where the user wants to pick up the vehicle 30.

The user can designate any location such as the pickup and drop-off area 202 in the parking area 2 or in front of the user's residence as the pickup location. For reservation use, the information processing device 10 dispatches the vehicle 30 assigned to reservation use so that the vehicle 30 of the model desired by the user arrives at the pickup location designated by the user a predetermined time before the pickup date and time. The vehicle 30 is a vehicle capable of autonomous driving, and autonomously heads for the pickup location designated by the user in response to a command received from the information processing device 10.

As described above, for reservation use, the user can reliably use the vehicle 30 of the desired model during the scheduled period of use. For reservation use, the user can also pick up the vehicle 30 at the desired pickup location. Accordingly, for example, when the user makes a planned use of the vehicle 30 for a family trip, distant business trip, etc., reservation use is highly convenient for the user.

On-demand use is the type of use in which the user requests the vehicle 30 parked in the on-demand waiting area 203 and uses the vehicle 30 immediately.

For on-demand use, the user goes to the on-demand waiting area 203, and when there is any vehicle 30 parked in the on-demand waiting area 203, the user requests the vehicle 30 parked in the on-demand waiting area 203. For on-demand use, the user operates the terminal device 20 to send request information for on-demand use to the information processing device 10.

A two-dimensional code including information necessary to request on-demand use is attached to the vehicle 30. For on-demand use, the user uses the camera 26 of the terminal device 20 to take a picture of the two-dimensional code attached to the vehicle 30 parked in the on-demand waiting area 203. The control unit 25 of the terminal device 20 sends information included in the two-dimensional code to the information processing device 10 via the communication unit 21. For example, the two-dimensional code may include identification information identifying the vehicle 30.

The request information for on-demand use that is sent by the user to the information processing device 10 includes information on scheduled return date and time. Unlike the request information for reservation use, the request information for on-demand use does not include information on a desired vehicle model, pickup date and time, and desired pickup location. One reason for this is that, for on-demand use, the user uses the vehicle 30 parked in the on-demand waiting area 203 and therefore cannot choose the vehicle model and the pickup location. Another reason for this is that, for on-demand use, the user starts using the vehicle 30 immediately and therefore information on pickup date and time is not necessary.

The control unit 15 of the information processing device 10 may control dispatching of the vehicles 30 so that only the vehicles 30 available for a minimum guaranteed service time or more are parked in the on-demand waiting area 203. As used herein, the minimum guaranteed service time is the minimum guaranteed time for which the user can use the vehicle 30 for on-demand use. For example, the minimum guaranteed service time may be 1.5 hours. Providing the minimum guaranteed service time as described above ensures that the user can use the vehicle 30 parked in the on-demand waiting area 203 for at least 1.5 hours for on-demand use.

As described above, for on-demand use, when there is any vehicle 30 parked in the on-demand waiting area 203, the user can use the vehicle 30 immediately. Accordingly, on-demand use is highly convenient for the user when the user wants to use the vehicle 30 immediately although he or she did not plan to, such as when going shopping or when picking up and dropping off someone in bad weather.

It is not like that a specific vehicle 30 is always used exclusively for a specific type of use, such as some vehicles 30 always used exclusively for reservation use and the other vehicles 30 always used exclusively for on-demand use. That is, whether a certain vehicle 30 is used as a vehicle for reservation use or a vehicle for on-demand use can be determined flexibly. In other words, the same vehicle 30 can be used for both reservation use and on-demand use.

Since the vehicles 30 are not exclusively used for one type of use, it is possible to increase the utilization rate of the vehicles 30 that can be used for the car sharing service.

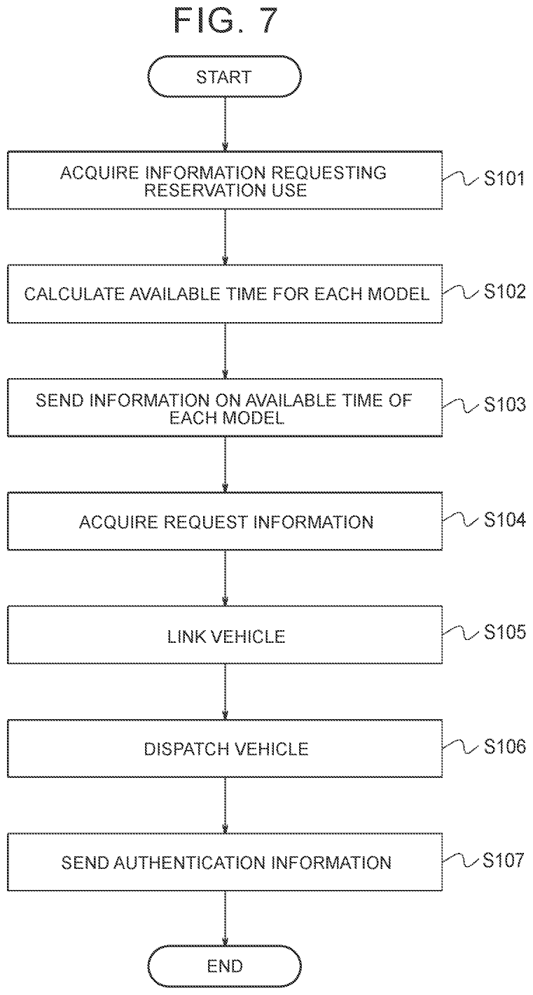

An overview of the operation of the information processing system 1 for reservation use will be described with reference to the flowchart of FIG. 7.

The input unit 23 of the terminal device 20 accepts an input requesting reservation use from the user who desires reservation use. The control unit 25 sends information requesting reservation use to the information processing device 10 via the communication unit 21.

The control unit 15 of the information processing device 10 acquires via the communication unit 11 the information requesting reservation use sent from the terminal device 20 (step S101).

The control unit 15 calculates an available time for each model of the vehicles 30 (step S102). For example, when there are two models of the vehicles 30, model A and model B, available for the car sharing service, the control unit 15 calculates an available time of model A and an available time of model B. Each available time calculated by the control unit 15 is the maximum time for which the vehicle 30 is available for reservation use.

The control unit 15 sends information on the available time of each vehicle model to the terminal device 20 via the communication unit 11 (step S103).

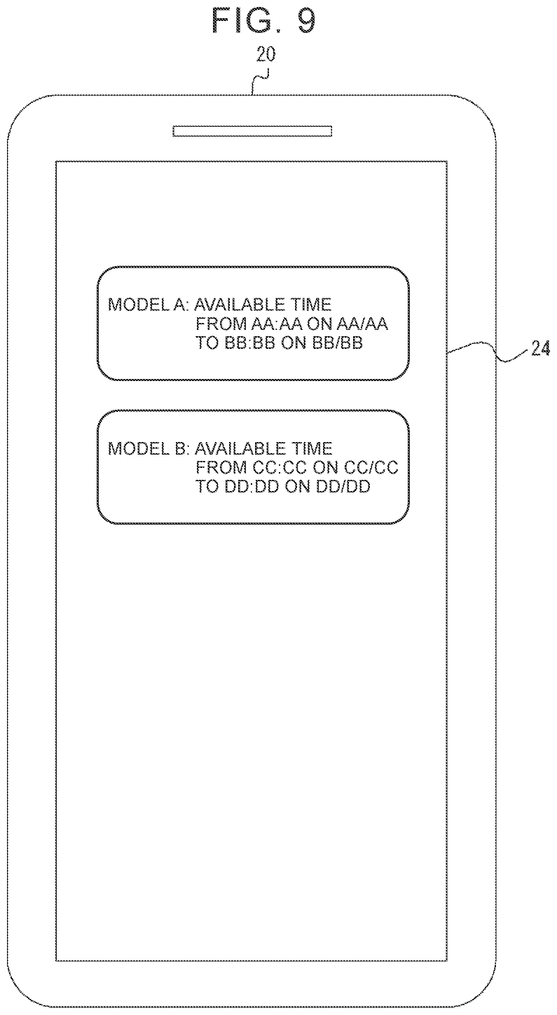

When the control unit 25 of the terminal device 20 acquires the information on the available time of each vehicle model, the control unit 25 causes the output unit 24 to display the information on the available time of each vehicle model. FIG. 9 shows an example of a screen of the output unit 24 displaying the information on the available time of each vehicle model.

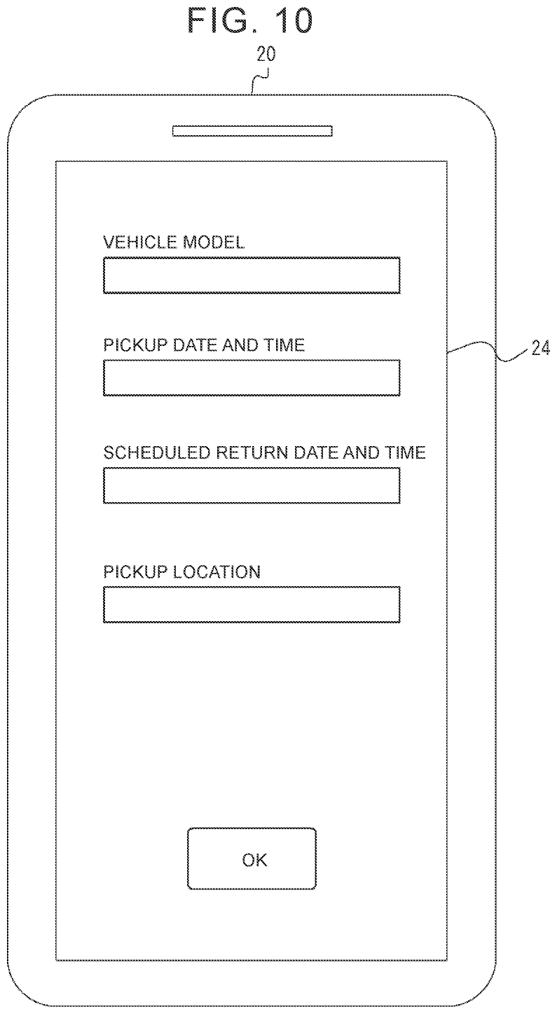

After checking the information on the available time of each vehicle model, the user enters request information for reservation use of the vehicle 30 to the input unit 23 of the terminal device 20. FIG. 10 shows an example of a screen of the output unit 24 displayed when the user is entering the request information. As shown in FIG. 10, the user enters information on the vehicle model, pickup date and time, scheduled return date and time, and pickup location. The control unit 25 sends the request information entered by the user to the information processing device 10 via the communication unit 21.

The control unit 15 of the information processing device 10 acquires via the communication unit 11 the request information sent from the terminal device 20 (step S104).

The control unit 15 links the vehicle 30 to the acquired request information (step S105). As used herein, linking the vehicle 30 means identifying the vehicle 30 to be used for reservation use based on the acquired required information. This means identifying the vehicle 30 to be provided for a service corresponding to a predetermined usage schedule recorded in data managing the usage schedule such as reservation tables. Linking of the vehicle 30 will be described in detail later.

The control unit 15 dispatches the vehicle 30 so that the vehicle 30 arrives at the desired pickup location a predetermined time before the pickup date and time (step S106). For example, the predetermined time may be 10 minutes. For example, when the pickup date and time is 10:00 on January 1st and the predetermined time is 10 minutes, the control unit 15 dispatches the vehicle 30 so that the vehicle 30 arrives at the desired pickup location by 9:50 on January 1st. When the vehicle 30 receives a dispatch command from the control unit 15, the vehicle 30 autonomously heads for the pickup location desired by the user.

The control unit 15 sends authentication information for the user to pick up the dispatched vehicle 30 to the terminal device 20 via the communication unit 11 (step S107).

The user can start using the vehicle 30 by going to the desired pickup location on the pickup date and time and performing an authentication process for the vehicle 30 parked at the pickup location using the authentication information acquired by the terminal device 20.

The user who has finished using the vehicle 30 may drop off the vehicle 30 at any location. For example, the user may drop off the vehicle 30 either in the pickup and drop-off area 202 of the parking area 2 or at other location. After the user drops off the vehicle 30, the vehicle 30 autonomously returns to the backyard 201 of the parking area 2.

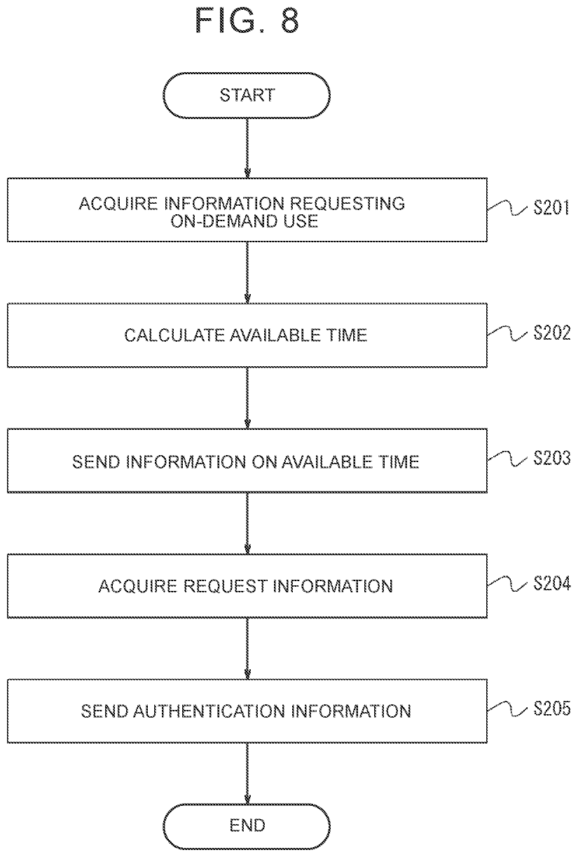

An overview of the operation of the information processing system 1 for on-demand use will be described with reference to the flowchart of FIG. 8.

The user who desires on-demand use goes to the on-demand waiting area 203 of the parking area 2. When there are more than one on-demand waiting area 203, the user may go to any on-demand waiting area 203. For example, the user may go to the on-demand waiting area 203 closest to his or her residence.

A two-dimensional code including information necessary to request on-demand use is attached to the vehicle 30. For on-demand use, the user uses the camera 26 of the terminal device 20 to take a picture of the two-dimensional code attached to the vehicle 30 parked in the on-demand waiting area 203. The control unit 25 of the terminal device 20 sends information included in the two-dimensional code to the information processing device 10 via the communication unit 21. For example, the two-dimensional code may include identification information identifying the vehicle 30. The control unit 25 sending the information included in the two-dimensional code means that the control unit 25 sends information requesting on-demand use to the information processing device 10 via the communication unit 21.

The control unit 15 of the information processing device 10 acquires via the communication unit 11 the information requesting on-demand use sent from the terminal device 20 (step S201).

The control unit 15 calculates an available time of the vehicle 30 (step S202). The vehicle 30 whose available time is calculated by the control unit 15 is the vehicle 30 for which the terminal device 20 took a picture of the two-dimensional code.

The control unit 15 sends information on the calculated available time to the terminal device 20 via the communication unit 11 (step S203).

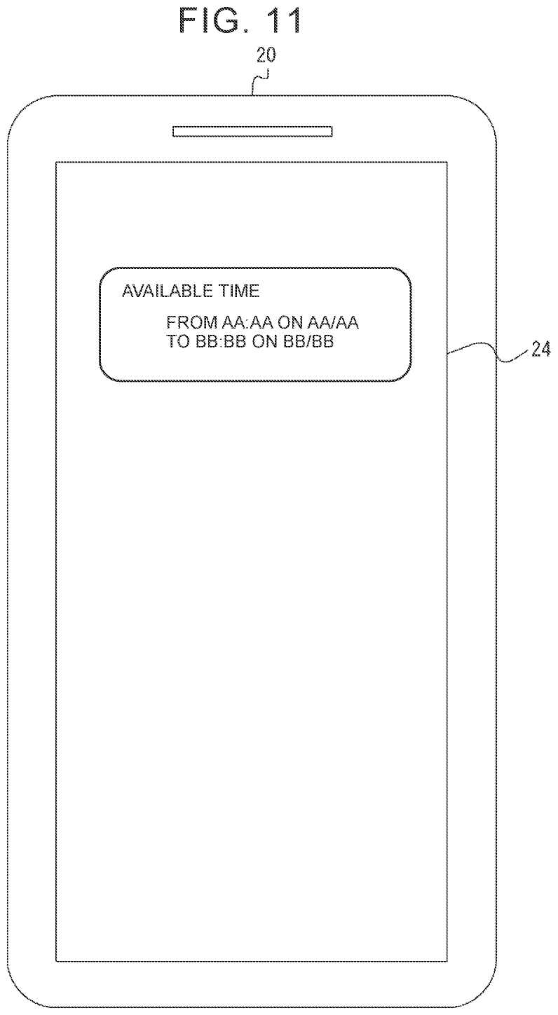

When the control unit 25 of the terminal device 20 acquires the information on the available time of the vehicle 30 parked in the on-demand waiting area 203, the control unit 25 causes the output unit 24 to display the information on the available time. FIG. 11 shows an example of a screen of the output unit 24 displaying the information on the available time of the vehicle 30 parked in the on-demand waiting area 203.

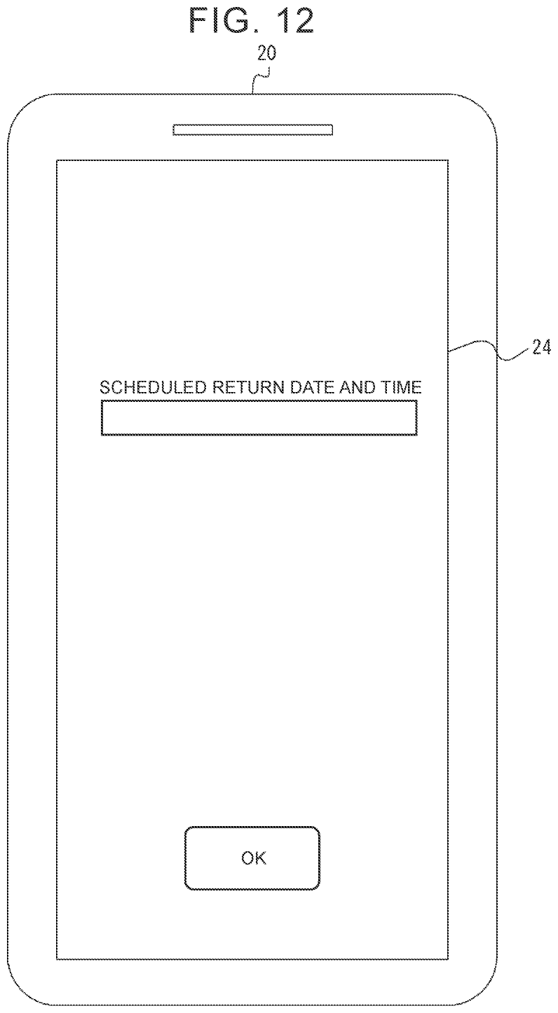

After checking the information on the available time of the vehicle 30 parked in the on-demand waiting area 203, the user enters request information for on-demand use of the vehicle 30 to the input unit 23 of the terminal device 20. FIG. 12 shows an example of a screen of the output unit 24 displayed when the user is entering the request information. As shown in FIG. 12, the user enters information on scheduled return date and time. The control unit 25 sends the request information entered by the user to the information processing device 10 via the communication unit 21.

The control unit 15 of the information processing device 10 acquires via the communication unit 11 the request information sent from the terminal device 20 (step S204).

The control unit 15 sends authentication information for the user to pick up the vehicle 30 parked in the on-demand waiting area 203 to the terminal device 20 via the communication unit 11 (step S205).

The user can start using the vehicle 30 by performing an authentication process for the vehicle 30 parked in the on-demand waiting area 203 using the authentication information acquired by the terminal device 20.

The user who has finished using the vehicle 30 may drop off the vehicle 30 at any location. For example, the user may drop off the vehicle 30 either in the pickup and drop-off area 202 of the parking area 2 or at other location. After the user drops off the vehicle 30, the vehicle 30 autonomously returns to the backyard 201 of the parking area 2.

Calculation of Available times for Reservation Use

The calculation of the available time for each vehicle model for reservation use shown in step S102 of the flowchart of FIG. 7 will be described in detail.

The control unit 15 of the information processing device 10 calculates the available time by subtracting a lead time and a downtime from the time available until the next reservation of the vehicle 30.

The lead time is the time set as an estimated time required to dispatch the reserved vehicle 30 to the pickup location desired by the user. For example, the lead time may be 30 minutes.

The downtime is the time set as a service unavailable time until the vehicle 30 becomes available to the next user after one user uses the vehicle 30. The downtime may be the time set in view of the time required to charge the vehicle 30, the time required to clean the vehicle 30, the time required to inspect the vehicle 30, etc.

Since the time required to charge the vehicle 30, the time required to clean the vehicle 30, etc. vary depending on the vehicle model, the downtime may be different for each vehicle model. For example, when there are two vehicle models, model A and model B, the downtime of model A may be set to three hours, and the downtime of model B may be set to one hour.

The control unit 15 calculates the available pickup date and time of the vehicle 30 for reservation use as the lead time after the current time. For example, when the current time is 10:00 on January 1st and the lead time is 30 minutes, the control unit 15 calculates the available pickup date and time of the vehicle 30 for reservation use as 10:30 on January 1st.

As described above, in the case of reservation use, the available pickup date and time of the vehicle 30 for reservation use is calculated as the lead time after the current time. Accordingly, when the user desires reservation use of the vehicle 30, the time that can be set as the available pickup date and time of the vehicle 30 for reservation use is the lead time after the current time or later.

The control unit 15 may set an upper limit on the available time when calculating the available time for reservation use. For example, the upper limit may be one week or two weeks. When the available time calculated by subtracting the lead time and the downtime from the time available until the next reservation of the vehicle 30 is longer than the upper limit of the available time, the control unit 15 may calculate the value of the upper limit of the available time as the available time.

The control unit 15 calculates the available time for each vehicle model. When there is more than one available vehicle 30 of the same model, the control unit 15 selects the longest available time of the vehicle 30 out of the available times calculated for the available vehicles 30 as the available time of this model.

The control unit 15 sends information on the calculated available time of each vehicle model to the terminal device 20 via the communication unit 11.

Calculation of Available Time for On-Demand Use

The calculation of the available time for on-demand use shown in step S202 of the flowchart of FIG. 8 will be described in detail.

The control unit 15 of the information processing device 10 calculates the available time by subtracting the downtime from the time available until the next reservation of the vehicle 30.

The control unit 15 calculates the available pickup date and time of the vehicle 30 for on-demand use as the current time. For example, when the current time is 10:00 on January 1st, the control unit 15 calculates the available pickup date and time of the vehicle 30 for on-demand use as 10:00 on January 1st.

As described above, in the case of on-demand use, the available pickup date and time of the vehicle 30 for on-demand use is calculated as the current time. Accordingly, in the case of on-demand use, the user can immediately use the vehicle 30.

The control unit 15 may set an upper limit on the available time when calculating the available time for on-demand use. For example, the upper limit may be 12 hours. When the available time calculated by subtracting the downtime from the time available until the next reservation of the vehicle 30 is longer than the upper limit of the available time, the control unit 15 may calculate the value of the upper limit of the available time as the available time.

As described above, the control unit 15 calculates the available time of the vehicle 30 by different methods depending on whether it is for reservation use or for on-demand use.

Reservation Tables

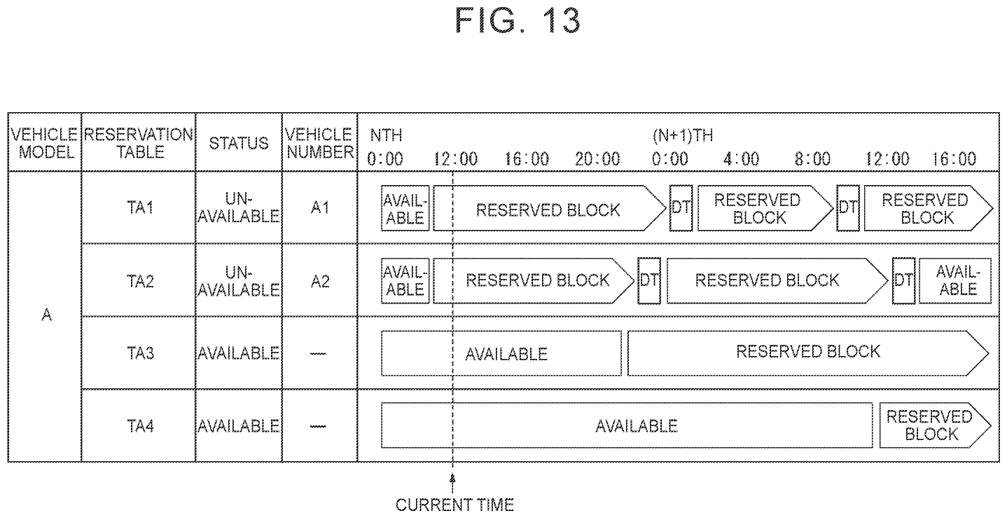

The control unit 15 of the information processing device 10 manages the usage schedule of the vehicles 30 by reservation tables. FIG. 13 shows an example of how the control unit 15 manages the vehicles 30 of model A by the reservation tables.

The number of reservation tables is the same as the number of vehicles 30 that are used for the car sharing service. The number of reservation tables for each model is the same as the number of vehicles 30 of that model.

For example, when there are 10 vehicles 30 of model A, 10 vehicles 30 of model B, and 10 vehicles of model C, the number of reservation tables for model A is 10, the number of reservation tables for model B is 10, and the number of reservation tables for model C is 10.

When the number of vehicles 30 available for the car sharing service has decreased due to regular service etc., the control unit 15 also reduces the number of reservation tables accordingly. For example, when the number of available vehicles 30 of model A has decreased from 10 to 9 due to regular service, the control unit 15 reduces the number of reservation tables for model A from 10 to 9.

No reservation table is exclusively linked to a specific vehicle 30. That is, which vehicle 30 uses the usage schedule being managed by a certain reservation table can be determined flexibly.

For reservation use, the control unit 15 determines a predetermined time before the start time of reservation use which vehicle 30 is to be linked to the reservation table. For example, the predetermined time may be 30 minutes.

For on-demand use, the control unit 15 determines in response to a request for on-demand use which vehicle 30 is to be linked to the reservation table.

FIG. 13 shows an example in which there are four vehicles 30 of model A and the control unit 15 manages the vehicles 30 of model A by four reservation tables TA1 to TA4. The reservation table includes information on the status, vehicle number, and schedule.

The status indicates whether the reservation table is “unavailable” or “available” at the current time. In the example shown in FIG. 13, the status of the reservation tables TA1 and TA2 is “unavailable” because the schedule for the current time is “reserved block.” A part marked with “reserved block” in the schedule means that a reservation has already been made for that time.

In the example shown in FIG. 13, the status of the reservation tables TA3 and TA4 is “available” because the schedule for the current time is “available.” Each portion marked with “available” in the “schedule” boxes means that no reservation has been made for that time.

The vehicle number indicates the vehicle 30 currently linked to the reservation table. In the example shown in FIG. 13, the vehicle 30 with vehicle number “A1” is currently linked to the reservation table TA1. This means that the vehicle 30 identified by the vehicle number “A1” has been used for the reservation from 11:00 on the Nth to 0:00 on the (N+1)th in the reservation table TA1. The vehicle 30 with vehicle number “A2” is currently linked to the reservation table TA2.

In the example shown in FIG. 13, the “vehicle number” boxes in the reservation tables TA3 and TA4 are blank. This means that the reservation tables TA3 and TA4 are currently not linked to specific vehicles 30.

In the example shown in FIG. 13, the “schedule” boxes are marked with “available,” “reserved block,” and “DT.” Each portion marked with “available” means that no reservation has been made for that time. Each portion marked with “reserved block” means that a reservation has already been made for that time. Each portion marked with “DT” means the downtime. Each portion marked with “reserved block” may be the total of the lead time and the time reserved by the user.

In the example shown in FIG. 13, when the information requesting reservation use is acquired from the user, there are available times in the reservation tables TA3 and TA4, but the available time in the reservation table TA4 is longer than that in the reservation table TA3. Accordingly, the control unit 15 sends the available time calculated for the reservation table TA4 to the terminal device 20 via the communication unit 11.

In the example shown in FIG. 13, since the current time is 12:00 on the Nth, the control unit 15 calculates the lead time after 12:00 on the Nth, namely 12:30 on the Nth, as the start date and time of the available time. It is herein assumed that the lead time is 30 minutes.

In the example shown in FIG. 13, the reservation table TA4 has a reservation from 12:00 on the (N+1)th. In this case, the control unit 15 calculates the downtime before 12:00 on the (N+1)th, namely 11:00 on the (N+1)th, as the end date and time of the available time. It is herein assumed that the downtime is one hour.

In this way, the control unit 15 calculates the available time of model A for reservation use as from 12:30 on the Nth to 11:00 on the (N+1)th.

In the example shown in FIG. 13, when the information requesting on-demand use of the vehicle 30 of model A parked in the on-demand waiting area 203 of the parking area 2 is acquired from the user, there are available times in the reservation tables TA3 and TA4, but the available time in the reservation table TA4 is longer than that in the reservation table TA3. Accordingly, the control unit 15 sends the available time calculated for the reservation table TA4 to the terminal device 20 via the communication unit 11.

For on-demand use, the start date and time of the available time is the current time that is 12:00 on the Nth.

As in the case of reservation use, the control unit 15 calculates the downtime before 12:00 on the (N+1)th, namely 11:00 on the (N+1)th, as the end date and time of the available time.

In this way, the control unit 15 calculates the available time for on-demand use as from 12:00 on the Nth to 11:00 on the (N+1)th.

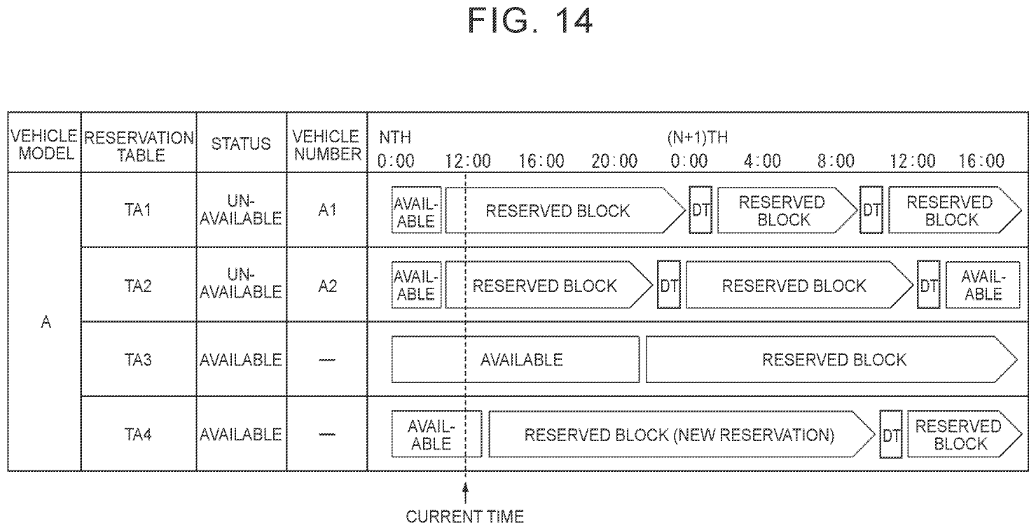

FIG. 14 shows an example in which the control unit 15 has added usage schedule information on a new reservation to the reservation table TA4. In the example shown in FIG. 14, the control unit 15 has added usage schedule information on a reservation from 13:00 on the Nth to 11:00 on the (N+1)th as the usage schedule information on a new reservation. The usage schedule information on a new reservation is shown as “reserved block (new reservation)” in FIG. 14. The usage schedule information may be the total of the lead time and the time reserved by the user. In that case, the control unit 15 adds the downtime after the usage schedule information on a new reservation. In the example shown in FIG. 14, the control unit 15 has added the downtime from 11:00 to 12:00 on the (N+1)th.

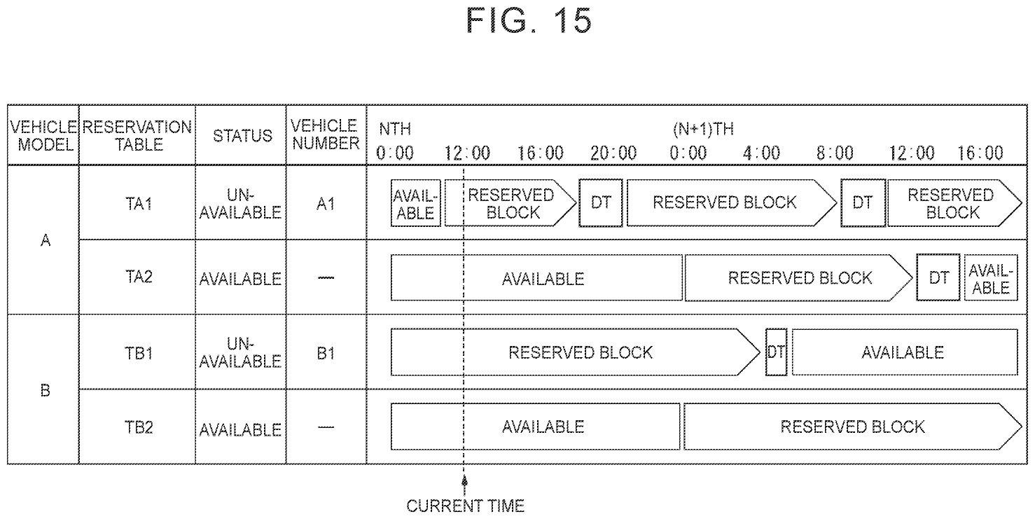

FIG. 15 shows an example of how the control unit 15 manages the vehicles 30 of models A and B by the reservation tables. FIG. 15 shows an example in which there are two vehicles 30 of model A and two vehicles 30 of model B. The control unit 15 manages the vehicles 30 of model A by two reservation tables TA1 and TA2. The control unit 15 also manages the vehicles 30 of model B by two reservation tables TB1 and TB2.

In the example shown in FIG. 15, when the information requesting reservation use is acquired from the user, there are available times in the reservation tables TA2 and TB2. The control unit 15 calculates the available time for model A based on the reservation table TA2. The control unit 15 calculates the available time for model B based on the reservation table TB2.

In the example shown in FIG. 15, both the reservation table TA2 for model A and the reservation table TB2 for model B are “available” from 12:00 on the Nth that is the current time to 0:00 on the (N+1)th. In the example shown in FIG. 15, however, the downtime varies between model A and model B. The downtime for model A is three hours, and the downtime for model B is one hour. Accordingly, the control unit 15 calculates different available times for model A and model B.

Specifically, the control unit 15 calculates that the available time for model A is from 12:30 on the Nth to 21:00 on the Nth. The control unit 15 calculates that the available time for model B is from 12:30 on the Nth to 23:00 on the Nth.

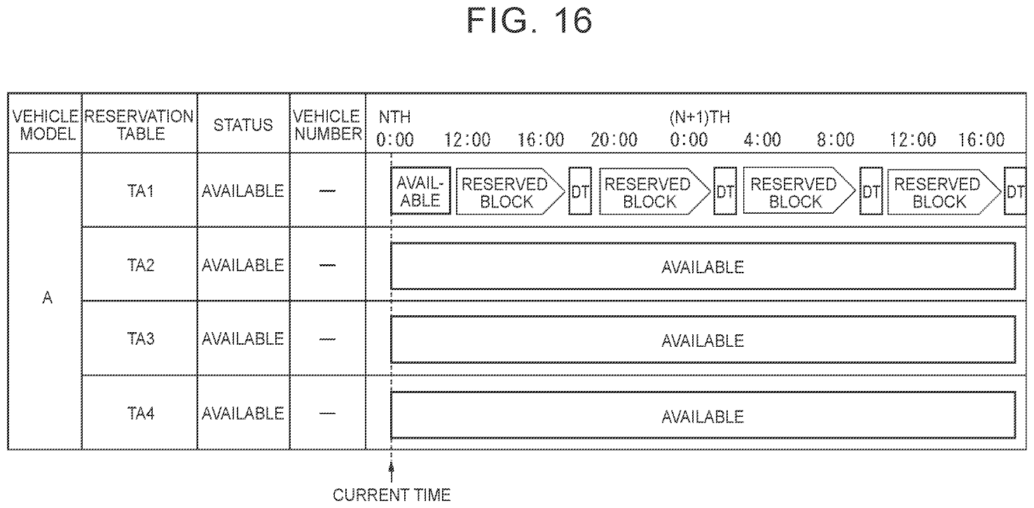

FIG. 16 shows an example of the reservation tables for model A when requests for reservation use have been acquired from four users.

In the example shown in FIG. 16, the control unit 15 has added four pieces of usage schedule information to the reservation table TA1. In this way, the control unit 15 can maximize the utilization rate of the vehicles 30 by adding as many pieces of usage schedule information as possible to one reservation table.

For example, when the four pieces of usage schedule information have been added to the four reservation tables TA1 to TA4, the fifth user cannot make a long time reservation of model A from the Nth to the (N+1)th. However, when the control unit 15 has added the pieces of usage schedule information to one reservation table as shown in FIG. 16, there are available times in the reservation tables TA2 to TA4. The fifth user can therefore make a long time reservation of model A from the Nth to the (N+1)th. As a result, the control unit 15 can maximize the utilization rate of the vehicles 30 of model A.

Linking in Reservation Use

For reservation use, the control unit 15 determines a predetermined time before the start time of reservation use which vehicle 30 is to be linked to the reservation table. For example, the predetermined time may be 30 minutes. In the case of reservation use, the control unit 15 determines based on a predetermined condition which vehicle 30 is to be preferentially linked to the reservation table.

Hereinafter, the predetermined condition for the control unit 15 to determine which vehicle 30 is to be preferentially linked to the reservation table will be described.

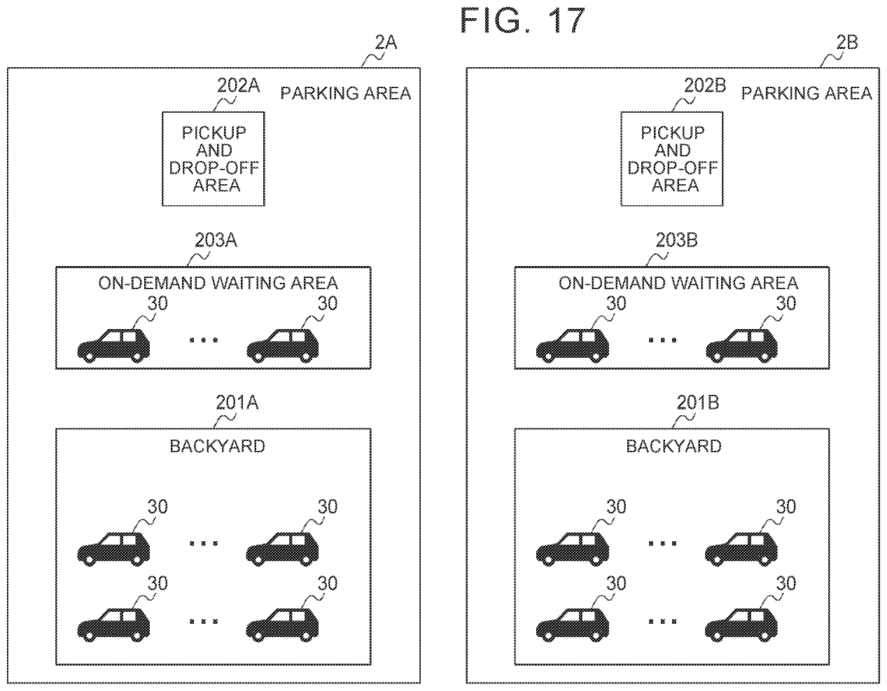

FIG. 17 shows an example in which there are two parking areas 2: a parking area 2A and a parking area 2B. The parking area 2A includes a backyard 201A, a pickup and drop-off area 202A, and an on-demand waiting area 203A. The parking area 2B includes a backyard 201B, a pickup and drop-off area 202B, and an on-demand waiting area 203B. For example, the parking area 2A and the parking area 2B may be separated from each other by about several hundred meters to about several kilometers.

The predetermined condition for the control unit 15 to determine which vehicle 30 is to be preferentially linked to the reservation table will be described with reference to FIG. 17.

When linking a specific vehicle 30 to the reservation table, the control unit 15 determines the order of priority based on the following first to third conditions, and links the vehicle 30 with a high level of priority to the reservation table. In this case, the control unit 15 links the vehicle 30 with a high level of priority to the reservation table out of the vehicles 30 of the model designated by the reservation table. For example, when the vehicle model designated by the reservation table is model A, the control unit 15 links the vehicle 30 of model A with a high level of priority to the reservation table out of the vehicles 30 of model A.

First Condition

The control unit 15 preferentially links the vehicle 30 waiting in the parking area 2 including the pickup location desired by the user to the reservation table over the vehicles 30 waiting in the parking area 2 not including the pickup location desired by the user.

For example, in FIG. 17, it is assumed that the pickup location desired by the user is the pickup and drop-off area 202A in the parking area 2A. It is also assumed that the user desires model A. In this case, the control unit 15 preferentially links the vehicle 30 of model A waiting in the parking area 2A to the reservation table over the vehicles 30 of model A waiting in the parking area 2B.

As the control unit 15 links the vehicle 30 waiting in the parking area 2A to the reservation table as described above, wasteful movement of the vehicles 30 can be reduced such as moving the vehicle 30 waiting in the parking area 2B to the pickup and drop-off area 202A in the parking area 2A.

Second Condition

The control unit 15 preferentially links the vehicle 30 waiting in the backyard 201 of the parking area 2 to the reservation table over the vehicles 30 waiting in the on-demand waiting area 203.

For example, in FIG. 17, it is assumed that the user desires model A and the vehicles 30 of model A are waiting in both the backyard 201A and the on-demand waiting area 203A. In this case, the control unit 15 preferentially links the vehicle 30 waiting in the backyard 201A to the reservation table over the vehicles 30 waiting in the on-demand waiting area 203A.

For example, when the vehicle 30 waiting in the on-demand waiting area 203A is linked to the reservation table, the vehicle 30 waiting in the on-demand waiting area 203A moves to the pickup and drop-off area 202A before the pickup date and time. In this case, it is necessary to replenish the on-demand waiting area 203A with other vehicle 30, one of the vehicles 30 waiting in the backyard 201A needs to be moved to an open spot in the on-demand waiting area 203A. As the control unit 15 preferentially links the vehicle 30 waiting in the backyard 201A to the reservation table over the vehicles 30 waiting in the on-demand waiting area 203A, such wasteful movement of the vehicles 30 can be reduced.

Third Condition

The control unit 15 preferentially links the vehicle 30 with the longest elapsed time since the end of the previous use to the reservation table.

For example, in FIG. 17, it is assumed that the user desires model A and a plurality of vehicles 30 of model A is waiting in the backyard 201A. In this case, the control unit 15 preferentially links the vehicle 30 with the longest elapsed time since the end of the previous use to the reservation table out of the vehicles 30 waiting in the backyard 201A.

As the control unit 15 preferentially links the vehicle 30 with the longest elapsed time since the end of the previous use to the reservation table, the operating states of the plurality of vehicles 30 can be leveled. This configuration makes it possible to reduce a possibility that a specific vehicle 30 is used more frequently.

The control unit 15 gives priority to the first condition over the second and third conditions. The control unit 15 gives priority to the second condition over the third condition.

Hereinafter, some cases will be specifically described. It is assumed that the pickup location desired by the user for reservation use is the pickup and drop-off area 202A of the parking area 2A and the user desires model A.

Case 1: A plurality of vehicles 30 of model A is waiting in the backyard 201A of the parking area 2A.

In this case, the control unit 15 preferentially links the vehicle 30 with the longest elapsed time since the end of the previous use to the reservation table out of the vehicles 30 of model A waiting in the backyard 201A.

Case 2: There is no vehicle 30 of model A waiting in the backyard 201A of the parking area 2A, and a plurality of vehicles 30 of model A is waiting in the on-demand waiting area 203A of the parking area 2A.

In this case, the control unit 15 preferentially links the vehicle 30 with the longest elapsed time since the end of the previous use to the reservation table out of the vehicles 30 of model A waiting in the on-demand waiting area 203A.

Case 3: There is no vehicle 30 of model A waiting in the parking area 2A, and a plurality of vehicles 30 of model A is waiting in the backyard 201B of the parking area 2B.

In this case, the control unit 15 preferentially links the vehicle 30 with the longest elapsed time since the end of the previous use to the reservation table out of the vehicles 30 of model A waiting in the backyard 201B of the parking area 2B.

Case 4: There is no vehicle 30 of model A waiting in the parking area 2A, there is no vehicle 30 of model A waiting in the backyard 201B of the parking area 2B, and a plurality of vehicles 30 of model A is waiting in the on-demand waiting area 203B of the parking area 2B.

In this case, the control unit 15 preferentially links the vehicle 30 with the longest elapsed time since the end of the previous use to the reservation table out of the vehicles 30 of model A waiting in the on-demand waiting area 203B of the parking area 2B.

Linking in On-Demand Use

For on-demand use, the control unit 15 determines in response to a request for on-demand use which reservation table is to be linked to the vehicle 30 parked in the on-demand waiting area 203.

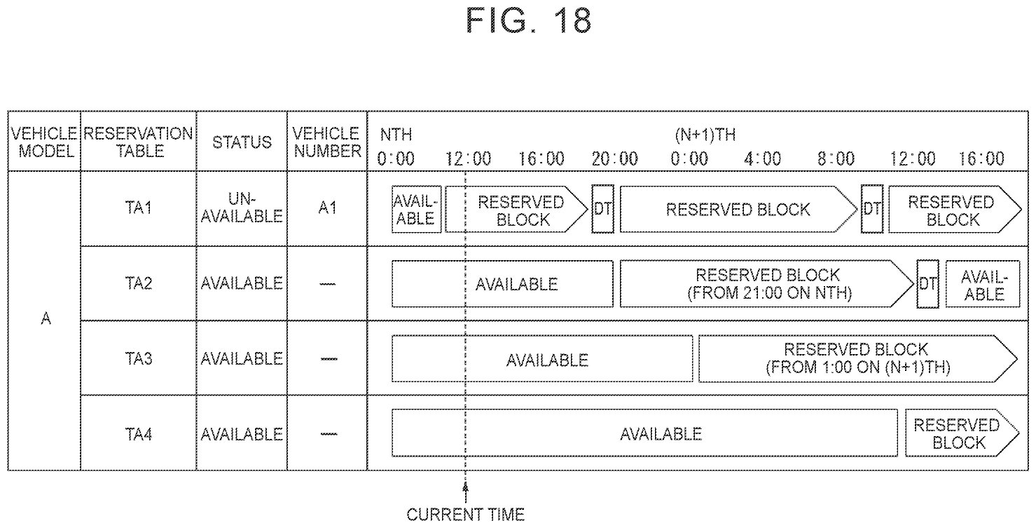

How the control unit 15 determines which reservation table is to be linked to the vehicle 30 parked in the on-demand waiting area 203 will be described with reference to FIG. 18. FIG. 18 shows an example of the reservation tables when a request for on-demand use has been accepted from the user.

It is assumed that the user has requested on-demand use of the vehicle 30 of model A parked in the on-demand waiting area 203. FIG. 18 shows the reservation tables for the vehicles 30 of model A at this time. Since there are four vehicles 30 of model A, there are four reservation tables TA1 to TA4. It is assumed that the vehicle number of the vehicle 30 of model A parked in the on-demand waiting area 203 is A2.

The control unit 15 links the reservation table whose status for the current time is “available” to the vehicle 30 parked in the on-demand waiting area 203.

Referring to FIG. 18, the status of the reservation table TA1 for 12:00 on the Nth that is the current time is “unavailable.” The control unit 15 therefore removes the reservation table TA1 from the list of candidate reservation tables to be linked. The status of the reservation tables TA2 to TA4 for 12:00 on the Nth that is the current time is “available.” The control unit 15 therefore considers the reservation tables TA2 to TA4 to be candidate reservation tables to be linked.

It is herein assumed that the scheduled return date and time entered to the terminal device 20 by the user who desires on-demand use of the vehicle 30 parked in the on-demand waiting area 203 is 21:00 on the Nth. Assuming that the downtime after on-demand use of the vehicle 30 is one hour, the reservation table needs to be available until 22:00 on the Nth.

In this case, since the reservation table TA2 has another reservation from 21:00 on the Nth, the control unit 15 removes the reservation table TA2 from the list of candidate reservation tables to be linked. The reservation tables TA3 and TA4 have no other reservation until 22:00 on the Nth. The control unit 15 therefore considers the reservation tables TA3 and TA4 to be candidate reservation tables to be linked.

When the status of the reservation table is “available” and there is a plurality of candidate reservation tables as described above, the control unit 15 links one of the candidate reservation tables to the vehicle 30 parked in the on-demand waiting area 203 so as to maximize the time available to a user who is going to use the vehicle 30 of model A next.

In the example shown in FIG. 18, when the reservation table TA3, for example, is linked to the vehicle 30 parked in the on-demand waiting area 203, the reservation table TA4 remains available. In this case, the user who is going to use the vehicle 30 of model A next can use the vehicle 30 of model A until 11:00 on the (N+1)th.

On the other hand, when the reservation table TA4 is linked to the vehicle 30 parked in the on-demand waiting area 203, the reservation table TA3 remains available. In this case, the user who is going to use the vehicle 30 of model A next can use the vehicle 30 of model A until 23:00 on the Nth.

As described above, linking the reservation table TA3 to the vehicle 30 parked in the on-demand waiting area 203 can maximize the time available to the user who is going to use the vehicle 30 of model A next. Therefore, in this case, the control unit 15 links the reservation table TA3 to the vehicle 30 parked in the on-demand waiting area 203.

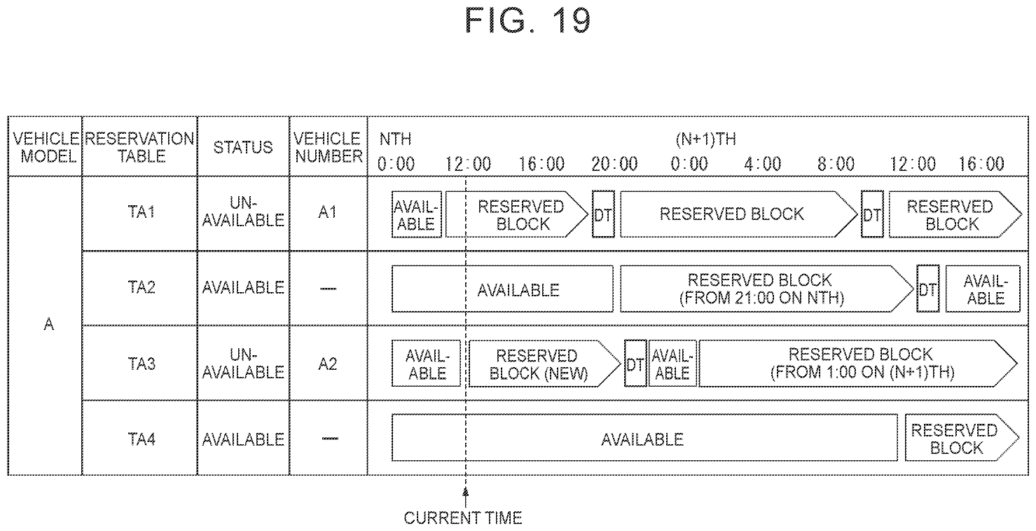

FIG. 19 shows an example in which the control unit 15 links the reservation table TA3 to the vehicle 30 parked in the on-demand waiting area 203.

As shown in FIG. 19, the control unit 15 links the reservation table TA3 to the vehicle 30 with vehicle number A2 parked in the on-demand waiting area 203. The control unit 15 can thus maximize the utilization rate of the vehicles 30 of model A.

Double Booking for Reservation Use and On-Demand Use

When the control unit 15 starts accepting a request for on-demand use from the user, the vehicle 30 requested for on-demand use may be excluded from the list of vehicles 30 for reservation use. This configuration can reduce a possibility that the vehicle 30 parked in the on-demand waiting area 203 becomes unavailable for on-demand use during processing of a request for on-demand use due to the vehicle 30 being included in the list of vehicles 30 for reservation use.

As described above, in the information processing device 10 according to the present embodiment, the control unit 15 acquires request information for the use of the vehicle 30 from the user as either request information for reservation use or request information for on-demand use. The control unit 15 manages the usage schedule of the vehicles 30 by the same number of reservation tables as the number of the vehicles 30. For reservation use, the control unit 15 determines a predetermined time before the start time of the reservation use which vehicle 30 is to be linked to the reservation table. As described above, the information processing device 10 can appropriately manage the vehicles 30 for both reservation use and on-demand use by using the reservation tables. Accordingly, both reservation use and on-demand use can be facilitated by using the information processing device 10 according to the present embodiment for the sharing car service.

The present disclosure is not limited to the above embodiment. For example, a plurality of blocks shown in the block diagram may be integrated into one block, or a block may be divided into a plurality of sub-blocks. Instead of performing the steps of the flowchart in chronological order according to the description, the steps may be performed in parallel or in a different order either according to the processing capability of the device that performs each step or as necessary. Other modifications can be made without departing from the spirit and scope of the present disclosure.

For example, a part of the processing operation performed by the information processing device 10 in the above embodiment may be performed by the terminal device 20 or the server device 40.

For example, a part of the processing operation performed by the terminal device 20 in the above embodiment may be performed by the information processing device 10 or the server device 40.

For example, a part of the processing operation performed by the server device 40 in the above embodiment may be performed by the information processing device 10 or the terminal device 20.

For example, in the above embodiment, the information processing device 10 and the server device 40 are described as independent devices. However, the information processing device 10 and the server device 40 may be an integrated device.

For example, a general-purpose electronic device such as smartphone or computer may be configured to function as the information processing device 10 according to the above embodiment. Specifically, programs including the processing content for implementing each function of the information processing device 10 etc. according to the embodiment are stored in a memory of the electronic device, and the programs are read and executed by a processor of the electronic device. The disclosure according to one embodiment can also be implemented as a program that can be executed by a processor.

Although an example in which there is a plurality of models of vehicles 30 that can be used for the car sharing service is described in the above embodiment, the number of models of vehicles 30 may be one.

What is claimed is:

1. An information processing device that manages vehicles used for a car sharing service, the information processing device comprising a processor configured to:
acquire either reservation use information or on-demand use information as request information for use of the vehicles from a user, the reservation use information being information on reservation use in which the user makes an advance reservation of the vehicles, and the on-demand use information being information on on-demand use in which use of the vehicles parked in an on-demand waiting area by the user is accepted;
manage a usage schedule of the vehicles by the same number of reservation tables as the number of the vehicles; and
when the processor acquires the reservation use information, determine, at a time point, which vehicle is designated as a vehicle to be used for the reservation use in a reservation table corresponding to the reservation use, the time point being a predetermined time before start time of the reservation use.

2. The information processing device according to claim 1, wherein the processor is configured to, when the processor acquires the reservation use information, determine based on a predetermined condition which vehicle is preferentially designated as the vehicle to be used for the reservation use in the reservation table corresponding to the reservation use.

3. The information processing device according to claim 2, wherein the reservation use information includes information on a desired vehicle model, pickup date and time, scheduled return date and time, and a desired pickup location.

4. The information processing device according to claim 3, wherein:
the processor is configured to, when the processor acquires the reservation use information, determine based on a first condition which vehicle is preferentially designated as the vehicle to be used for the reservation use in the reservation table corresponding to the reservation use; and
the first condition is that the vehicle waiting in a parking area including the desired pickup location is preferentially designated as the vehicle to be used for the reservation use in the reservation table corresponding to the reservation use over the vehicle waiting in a parking area not including the desired pickup location.

5. The information processing device according to claim 4, wherein:
the processor is configured to, when the processor acquires the reservation use information, determine based on a second condition which vehicle is preferentially designated as the vehicle to be used for the reservation use in the reservation table corresponding to the reservation use; and
the second condition is that the vehicle waiting in a backyard of the parking area is preferentially designated as the vehicle to be used for the reservation use in the reservation table corresponding to the reservation use over the vehicle waiting in the on-demand waiting area.

6. The information processing device according to claim 5, wherein:
the processor is configured to, when the processor acquires the reservation use information, determine based on a third condition which vehicle is preferentially designated as the vehicle to be used for the reservation use in the reservation table corresponding to the reservation use; and
the third condition is that the vehicle with a longest elapsed time since end of previous use is preferentially designated as the vehicle to be used for the reservation use in the reservation table corresponding to the reservation use.

7. The information processing device according to claim 6, wherein the processor is configured to give priority to the first condition over the second condition and the third condition and give priority to the second condition over the third condition.

8. A non-transitory computer-readable storage medium storing a program, the program being a program that, when executed by a processor, causes a computer that manages vehicles used for a car sharing service to:
acquire either reservation use information or on-demand use information as request information for use of the vehicles from a user, the reservation use information being information on reservation use in which the user makes an advance reservation of the vehicles, and the on-demand use information being information on on-demand use in which use of the vehicles parked in an on-demand waiting area by the user is accepted;
manage a usage schedule of the vehicles by the same number of reservation tables as the number of the vehicles; and
when the computer acquires the reservation use information, determine, at a time point, which vehicle is designated as a vehicle to be used for the reservation use in a reservation table corresponding to the reservation use, the time point being a predetermined time before start time of the reservation use.

9. The storage medium according to claim 8, wherein when the program is executed by the processor, the program causes the computer to, when the computer acquires the reservation use information, determine based on a predetermined condition which vehicle is preferentially designated as the vehicle to be used for the reservation use in the reservation table corresponding to the reservation use.

10. The storage medium according to claim 9, wherein the reservation use information includes information on a desired vehicle model, pickup date and time, scheduled return date and time, and a desired pickup location.

11. The storage medium according to claim 10, wherein:
when the program is executed by the processor, the program causes the computer to, when the computer acquires the reservation use information, determine based on a first condition which vehicle is preferentially designated as the vehicle to be used for the reservation use in the reservation table corresponding to the reservation use; and
the first condition is that the vehicle waiting in a parking area including the desired pickup location is preferentially designated as the vehicle to be used for the reservation use in the reservation table corresponding to the reservation use over the vehicle waiting in a parking area not including the desired pickup location.

12. The storage medium according to claim 11, wherein:
when the program is executed by the processor, the program causes the computer to, when the computer acquires the reservation use information, determine based on a second condition which vehicle is preferentially designated as the vehicle to be used for the reservation use in the reservation table corresponding to the reservation use; and
the second condition is that the vehicle waiting in a backyard of the parking area is preferentially designated as the vehicle to be used for the reservation use in the reservation table corresponding to the reservation use over the vehicle waiting in the on-demand waiting area.

13. The storage medium according to claim 12, wherein:
when the program is executed by the processor, the program causes the computer to, when the computer acquires the reservation use information, determine based on a third condition which vehicle is preferentially designated as the vehicle to be used for the reservation use in the reservation table corresponding to the reservation use; and
the third condition is that the vehicle with a longest elapsed time since end of previous use is preferentially designated as the vehicle to be used for the reservation use in the reservation table corresponding to the reservation use.

14. The storage medium according to claim 13, wherein when the program is executed by the processor, the program causes the computer to give priority to the first condition over the second condition and the third condition and give priority to the second condition over the third condition.

15. An information processing method in an information processing device that manages vehicles used for a car sharing service, the information processing method comprising:
acquiring either reservation use information or on-demand use information as request information for use of the vehicles from a user, the reservation use information being information on reservation use in which the user makes an advance reservation of the vehicles, and the on-demand use information being information on on-demand use in which use of the vehicles parked in an on-demand waiting area by the user is accepted;
managing a usage schedule of the vehicles by the same number of reservation tables as the number of the vehicles; and
when the reservation use information is acquired, determining, at a time point, which vehicle is designated as a vehicle to be used for the reservation use in a reservation table corresponding to the reservation use, the time point being a predetermined time before start time of the reservation use.

16. The information processing method according to claim 15, further comprising when the reservation use information is acquired, determining based on a predetermined condition which vehicle is preferentially designated as the vehicle to be used for the reservation use in the reservation table corresponding to the reservation use.

17. The information processing method according to claim 16, wherein the reservation use information includes information on a desired vehicle model, pickup date and time, scheduled return date and time, and a desired pickup location.

18. The information processing method according to claim 17, further comprising when the reservation use information is acquired, determining based on a first condition which vehicle is preferentially designated as the vehicle to be used for the reservation use in the reservation table corresponding to the reservation use, wherein the first condition is that the vehicle waiting in a parking area including the desired pickup location is preferentially designated as the vehicle to be used for the reservation use in the reservation table corresponding to the reservation use over the vehicle waiting in a parking area not including the desired pickup location.

19. The information processing method according to claim 18, further comprising when the reservation use information is acquired, determining based on a second condition which vehicle is preferentially designated as the vehicle to be used for the reservation use in the reservation table corresponding to the reservation use, wherein the second condition is that the vehicle waiting in a backyard of the parking area is preferentially designated as the vehicle to be used for the reservation use in the reservation table corresponding to the reservation use over the vehicle waiting in the on-demand waiting area.

20. The information processing method according to claim 19, further comprising when the reservation use information is acquired, determining based on a third condition which vehicle is preferentially designated as the vehicle to be used for the reservation use in the reservation table corresponding to the reservation use, wherein the third condition is that the vehicle with a longest elapsed time since end of previous use is preferentially designated as the vehicle to be used for the reservation use in the reservation table corresponding to the reservation use.
